(19) United States
(12) Patent Application Publication
(10) Pub. No.: US 2025/0329198 A1
(43) Pub. Date: Oct. 23, 2025

(54) ELECTRIFIED VEHICLE AND DISPLAYING DEVICE

(71) Applicant: TOYOTA JIDOSHA KABUSHIKI KAISHA, Toyota-shi (JP)

(72) Inventor: Hirotaka SASAKI, Nagoya-shi (JP)

(73) Assignee: TOYOTA JIDOSHA KABUSHIKI KAISHA, Toyota-shi (JP)

(21) Appl. No.: 19/058,212

(22) Filed: Feb. 20, 2025

(30) Foreign Application Priority Data
Apr. 22, 2024 (JP) 2024-068843

(51) Int. Cl. G07C 5/08; B60L 50/60; B60L 58/12; B60L 58/24; H01M 10/48; H01M 10/61; H01M 10/63

(52) U.S. Cl. CPC G07C 5/0825; B60L 50/60; B60L 58/12; B60L 58/24; H01M 10/488; H01M 10/61; H01M 10/63; B60L 2240/545; B60L 2250/16; H01M 2220/20

(57) ABSTRACT

Electrified vehicle includes a processor, a display device, a battery, and a cooling/temperature raising device that adjusts a temperature of the battery according to a user's manipulation using power stored in the battery. The processor calculates a comparison index value relating to the storage amount of the battery between the case where the cooling/temperature raising device is operated and the case where the cooling/temperature raising device is not operated, and displays the calculated comparison index value on the display device. It is possible to notify the user of electrified vehicle of the power storage capacity of the battery when the cooling/temperature raising device that adjusts the temperature of the battery in response to the user's manipulation is operated by using the electric power stored in the battery that stores the electric power for traveling of electrified vehicle and when the cooling/temperature raising device is not operated.

### CROSS-REFERENCE TO RELATED APPLICATION

This application claims priority to Japanese Patent Application No. 2024-068843 filed on Apr. 22, 2024, incorporated herein by reference in its entirety.

### BACKGROUND

### 1. Technical Field

The present disclosure relates to an electrified vehicle and a display device. In particular, the present disclosure relates to an electrified vehicle that informs a user of information about electric power for travel, and a display device that informs a user of information about electric power for travel of an electrified vehicle.

### 2. Description of Related Art

Conventionally, there has been a display device, in an electrified vehicle, that displays a travelable distance that varies depending on the presence or absence of air conditioning based on the average speed of the vehicle and the power consumed by the air conditioning (see Japanese Unexamined Patent Application Publication No. 2021-141673 (JP 2021-141673 A), for example).

### SUMMARY

In the electrified vehicle, in addition to the air conditioning, electric power may be consumed for applications other than travel. For example, when a charging facility is set as a destination, the electric power of the battery is consumed by activating a function of adjusting the temperature of the battery in advance in order to increase the charging efficiency. For this reason, there is room for improvement about what display is to be made for the user of the electrified vehicle regarding the consumption of the battery.

The present disclosure has been made to address the issue described above, and an object of the present disclosure is to provide an electrified vehicle and a display device capable of informing a user of information about the power storage amount of a power storage device in an easily understandable manner.

An aspect of the present disclosure provides an electrified vehicle that informs a user of information about electric power for travel, including:
a processor;
a display device;
a power storage device that stores electric power for travel; and
a temperature adjusting device that adjusts a temperature of the power storage device according to an operation by the user using the electric power stored in the power storage device.

The processor is configured to: calculate a comparison index value relating to a power storage amount of the power storage device in a case where the temperature adjusting device is caused to operate and a case where the temperature adjusting device is not caused to operate; and
cause the display device to display the calculated comparison index value.

According to such a configuration, the user of the electrified vehicle can be informed of a value for comparing the power storage amount of the power storage device that stores the electric power for travel of the electrified vehicle in a case where the temperature adjusting device that adjusts the temperature of the power storage device is caused to operate and a case where the temperature adjusting device is not caused to operate, according to an operation by the user using the electric power stored in the power storage device. As a result, it is possible to provide an electrified vehicle capable of informing the user of information about the power storage amount of the power storage device in an easily understandable manner.

Another aspect of the present disclosure provides a display device that informs a user of information about electric power for travel of an electrified vehicle, in which
the display device is caused to display a comparison index value relating to a power storage amount of a power storage device that stores electric power for travel in a case where a temperature adjusting device that adjusts a temperature of the power storage device is caused to operate and a case where the temperature adjusting device is not caused to operate.

According to such a configuration, it is possible to provide a display device capable of informing the user of information about the power storage amount of the power storage device in an easily understandable manner.

The comparison index value may be a parameter relating to the power storage amount at a time when a destination is reached in a case where the temperature adjusting device is caused to operate and a case where the temperature adjusting device is not caused to operate.

According to such a configuration, it is possible to inform the user, in an easily understandable manner, of information about the power storage amount at the time when the destination is reached in a case where the temperature adjusting device is caused to operate and a case where the temperature adjusting device is not caused to operate.

The comparison index value may be a parameter corresponding to the power storage amount that is reduced by use of the temperature adjusting device before it becomes impossible to travel using the electric power in the power storage device.

According to such a configuration, it is possible to inform the user, in an easily understandable manner, of information about the power storage amount that is reduced by the use of the temperature adjusting device before it becomes impossible to travel using the electric power in the power storage device.

A value relating to a cruising distance may be preferentially displayed as the comparison index value while the electrified vehicle is traveling or when a destination of the electrified vehicle is set, and
a value relating to a state of charge (SOC) may be preferentially displayed as the comparison index value while the power storage device is being externally charged or when a charging plug is connected to the electrified vehicle.

According to such a configuration, it is possible to selectively inform the user of a value related to the cruising distance or a value related to the SOC, depending on the situation. As a result, the convenience for the user can be improved.

According to the present disclosure, it is possible to provide an electrified vehicle and a display device capable of informing a user of information about the power storage amount of a power storage device in an easily understandable manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an entire configuration diagram of an electrified vehicle according to this embodiment;

FIG. 2 is a flowchart showing a flow of a battery display process in this embodiment;

FIG. 3A is a diagram illustrating an exemplary mode of displaying a remaining amount of a display relating to an electric storage amount of a battery in a meter panel according to the embodiment;

FIG. 3B is a diagram illustrating another example of an aspect of a remaining amount display of a display relating to a stored amount of a battery in a meter panel in this embodiment;

FIG. 4A is a diagram illustrating an example of an SOC display mode of a display relating to the amount of electricity stored in a battery in a meter panel according to an embodiment of the present disclosure;

FIG. 4B illustrates another exemplary aspect of an SOC indication of the amount of charge stored in the battery in the meter panel of this embodiment;

FIG. 4C illustrates another exemplary aspect of an SOC indication of the amount of charge stored in the battery in the meter panel of this embodiment;

FIG. 4D illustrates another exemplary aspect of an SOC indication of the amount of charge stored in the battery in the meter panel of this embodiment;

FIG. 5A is a diagram illustrating an example of a cruising distance display mode of a display relating to an electric storage amount of a battery in a meter panel according to the embodiment;

FIG. 5B illustrates another example of an aspect of a range indication of a display relating to the amount of power storage of a battery in a meter panel in this embodiment;

FIG. 5C illustrates another example of an aspect of a range indication of a display relating to the amount of power storage of a battery in a meter panel in this embodiment;

FIG. 5D illustrates another example of an aspect of a range indication of a display relating to the amount of power storage of a battery in a meter panel in this embodiment;

FIG. 6A is a diagram showing an exemplary aspect of an arrival-time display of a display relating to a stored amount of a battery in a meter panel in this embodiment; and

FIG. 6B is a diagram showing another exemplary aspect of an arrival-time display of a display relating to the amount of power stored in a battery in a meter panel in this embodiment.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

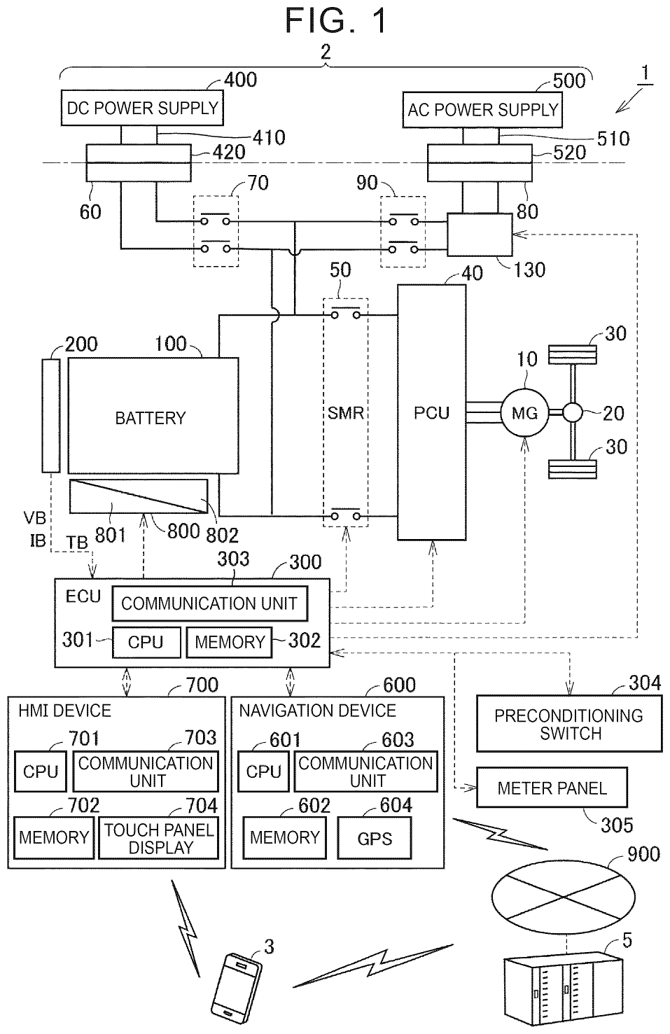

FIG. 1 is an entire configuration diagram of an electrified vehicle 1 according to this embodiment. In this embodiment, electrified vehicle 1 is, for example, battery electric vehicle (BEV). Electrified vehicle 1 includes Motor Generator (MG) 10 which is a rotating electric machine, power transmission gears 20, drive wheels 30, Power Control Unit (PCU) 40, System Main Relay (SMR) 50, battery 100, monitoring unit 200, and Electronic Control Unit (ECU) 300.

MG 10 is, for example, an embedded-structure permanent-magnet synchronous motor (IPM motor), and has a function as an electric motor and a function as a generator. The output-torque of MG 10 is transmitted to the drive wheels 30 via the power transmission gears 20 including a speed reducer, a differential, and the like.

When electrified vehicle 1 is braked, MG 10 is driven by the drive wheels 30, and MG 10 operates as a generator. As a result, MG 10 also functions as a braking device that performs regenerative braking for converting kinetic energy of electrified vehicle 1 into electric power. The regenerative electric power generated by the regenerative braking force in MG 10 is stored in the battery 100.

PCU 40 is a power converter that bi-directionally converts power between MG 10 and the battery 100. PCU 40 includes, for example, inverters and converters that operate based on control signals from ECU 300. PCU 40 may have a configuration in which the converters are omitted.

SMR 50 is electrically connected to a power line connecting the battery 100 and PCU 40. If SMR 50 is ON (conductive) in response to a control signal from ECU 300, power may be exchanged between the battery 100 and PCU 40. On the other hand, when SMR 50 is OFF in response to a control signal from ECU 300, the battery 100 is disconnected from PCU 40.

The battery 100 stores electric power for driving MG 10. The battery 100 is a rechargeable DC power source (secondary battery), and is configured by stacking a plurality of unit cells (battery cells) and electrically connecting them in series, for example. The battery 100 corresponds to a storage battery. The unit cell is composed of, for example, a lithium-ion battery. The unit cell may be a nickel metal hydride battery or an all-solid-state battery.

The monitoring unit 200 includes a voltage detection unit, a current sensor, and a temperature detection unit. The voltage detector detects a voltage VB of the battery. The current sensor detects a current IB input to and output from the battery 100. The temperature detector 230 detects a temperature TB of the battery 100. The detection unit outputs the detection result to ECU 300.

Electrified vehicle 1 includes a DC inlet 60 and an AC inlet 80. Electrified vehicle 1 can charge (externally charge) the battery 100 from the external DC power supply 400 or EVSE (charging facility) 2 including the external AC power supply 500 or the like. DC inlet 60 is configured to be connectable to a connector 420 provided at a distal end of a charge cable 410 of an external DC power supply (EVSE) 400. The charging relay 70 is electrically connected to a power line connecting DC inlet 60 and the battery 100. The charging relay 70 switches between supplying and shutting off power between DC inlet 60 and the battery 100 in response to a control signal from ECU 300. When the charging relay 70 is closed, external charging (quick charging) of the battery 100 is performed.

AC inlet 80 is configured to be connectable to a connector 520 provided at a distal end of a charge cable 510 of an external AC power supply (EVSE) 500. An in-vehicle charger 130 is provided in a power line between AC inlet 80 and the battery 100, and converts AC power supplied from an external AC power source into DC power and converts the battery 100 into a chargeable voltage. The charging relay 90 is electrically connected to a power line connecting the in-vehicle charger 130 and the battery 100. The charging relay 90 switches between supplying and shutting off the electric power between the in-vehicle charger 130 and the battery 100 in response to a control signal from ECU 300. When the charging relay 90 is closed, external charging (normal charging) of the battery 100 is performed. When electrified vehicle 1 (battery 100) is charged, external charging is performed using either the external DC power supply 400 or the external AC power supply 500.

ECU 300 includes Central Processing Unit (CPU) 301, memories 302, and communication units 303. The memories 302 include, for example, Read Only Memory (ROM) and Random Access Memory (RAM). ECU 300 controls the devices so that electrified vehicle 1 is in a desired condition based on the signals received from the monitoring unit 200, signals from various sensors (not shown), maps and programs stored in the memories 302, and the like. The signals from the various sensors are, for example, an accelerator operation amount signal, a vehicle speed signal, and the like. The communication unit 303 includes a communication interface (I/F) for wirelessly communicating with the network 900 and the user terminal 3. The communication unit 303 may include a Telematics Control Unit (TCU) for performing radio communication and/or a data Communication Module (DCM). ECU 300 also controls a cooling/temperature raising device 800, which will be described later.

The navigation device 600 calculates the present position (vehicle position) on the basis of the map data including information such as the position of EVSE and information such as outputting, and Global Positioning System (GPS) information. EVSE is, for example, DC power supply 400 and AC power supply 500. The navigation device 600 includes a CPU 601 similar to that of ECU 300, a memory 602, a communication unit 603, a GPS 604, and the like, and is realized by executing a program stored in the memory. The navigation device 600 guides a route to a destination set by the user. It is also possible to set a via point on a route to a destination. The map data may be acquired by communication via the external server 5 and the network 900.

A Human Machine Interface (HMI) device 700 includes an input device and a display device. HMI device 700 includes a touch panel display 704 that functions as an input device and a display device in addition to CPU 701, the memories 702, and the communication unit 703 similar to ECU 300. In HMI device 700, the touch panel display 704 is also used as an input device and a display device of the navigation device 600.

The user terminal 3 is configured to be portable by a user. The user terminal 3 is a mobile terminal that is carried and operated by a user (vehicle administrator) of electrified vehicle 1. In the present embodiment, a smartphone including a touch panel display is adopted as the user terminal 3. As the user terminal 3, any terminal that can be carried by a user of electrified vehicle 1 can be employed. For example, a laptop, a tablet terminal, a portable game machine, a wearable device (smart watch, smart glass, smart glove, or the like) and the like can also be employed as the user terminal 3. The user terminal 3 can communicate with the communication unit 303 by, for example, short-range wireless communication, and can communicate with the external server 5 via the network 900.

Electrified vehicle 1 comprises a cooling/temperature raising device 800. The cooling/temperature raising device 800 adjusts the temperature of the battery 100. Hereinafter, the temperature adjustment is also referred to as “temperature control”. The cooling/temperature raising device 800 includes a battery cooling unit (battery cooling system) 801 and a battery temperature raising unit (battery temperature raising system) 802. The cooling/temperature raising device 800 may be configured to cool/raise the temperature of the battery 100. The cooling/temperature raising device 800 may be air cooling (heat exchange using a gas as a medium) or liquid cooling (heat exchange using a liquid as a medium). The cooling/temperature raising device 800 may utilize exhaust heat from a MG 10 or a PCU 40, or may utilize heat generated by charging and discharging of the battery 100.

In the battery 100, an appropriate charging power (charging current) is present in accordance with the temperature TB of the battery 100, and when charging is performed with a current exceeding the appropriate charging power, degradation of the battery 100 may be accelerated. In addition, when the battery 100 performs charging with a current exceeding the acceptable power (allowable power), the charging efficiency deteriorates, and the power consumption at the time of charging deteriorates. When the charging power (charging current) is limited when the temperature TB is higher or lower in order to suppress degradation of the battery 100 or the like, the charging time becomes longer depending on the condition of the temperature TB. Therefore, in a case where external charging of the battery 100 is assumed, it is preferable to adjust the temperature of the battery 100 to an appropriate temperature range in advance before charging is started.

Conventionally, in an electrified vehicle 1, there has been a HMI device 700 that displays a travelable range that varies with the presence or absence of air conditioning based on the mean velocity of electrified vehicle 1 and the power consumed by the air conditioning. In electrified vehicle 1, in addition to air conditioning, power may be consumed in applications other than driving. For example, when the charging facility is set at the destination by the navigation device 600, the power of the battery 100 is consumed by operating the cooling/temperature raising device 800 in order to adjust the temperature of the battery 100 in advance in order to increase the charging efficiency. For this reason, there is room for improvement in what kind of indication regarding the consumption of the battery 100 is performed for the user of electrified vehicle 1.

Therefore, the processor, such as CPU 301 of ECU 300 or CPU 701 of HMI device 700, calculates a comparison index for the amount of electricity stored in the battery 100 between the case where the cooling/temperature raising device 800 is operated and the case where it is not operated. The processor displays the calculated comparative index on the touch panel display 704 of HMI device 700.

Accordingly, the user of electrified vehicle 1 can be notified of the power storage amount of the battery 100 between the case where the cooling/temperature raising device 800 is operated and the case where it is not operated. The cooling/temperature raising device 800 is a device that adjusts the temperature of the battery 100 in accordance with a user's manipulation by using the electric power stored in the battery 100 that stores the electric power for traveling of electrified vehicle 1. As a result, it is possible to easily inform the user of information regarding the amount of electric power stored in the battery 100.

As shown in FIG. 1, electrified vehicle 1 further comprises a preconditioning switch 304 for activating or deactivating the cooling/temperature raising device 800. When the preconditioning switch 304 is operated to start the operation of the cooling/temperature raising device 800, the temperature of the battery 100 is adjusted to a temperature range suitable for charging.

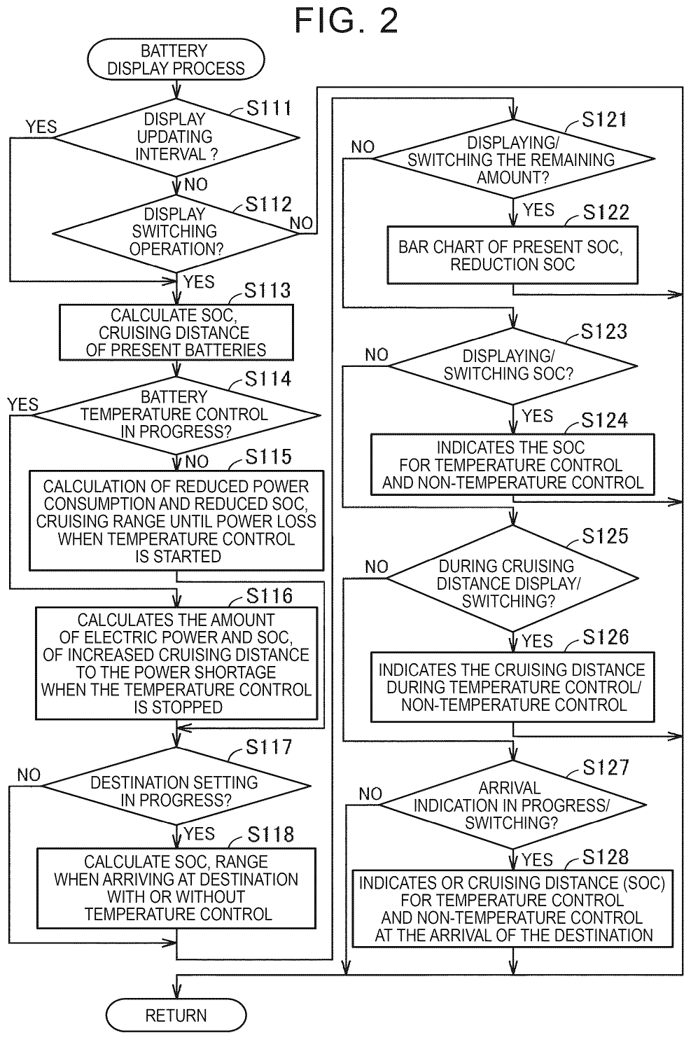

FIG. 2 is a flowchart showing a flow of a battery display process in this embodiment. Referring to FIG. 2, the battery-displaying process is executed by CPU 301 of ECU 300 after being called at predetermined intervals from the higher-level process.

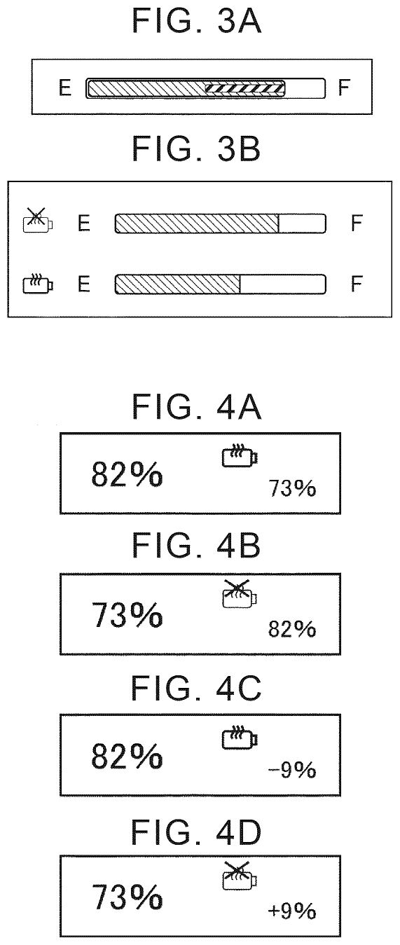

CPU 301 of ECU 300 determines whether or not it is the updating cycle of the indication (refer to FIG. 3A, FIG. 3B, and FIG. 4A to FIG. 4D, which will be described later) regarding the storage capacity of the battery 100 of the meter panel 305 (S111). If it is determined that the display is not updated (NO in S111), CPU 301 determines whether or not the user has operated to switch the display mode related to the power storage capacity of the battery 100 (S112). When it is determined that the display switching operation is not performed (NO in S112), CPU 301 returns the processing to be executed to the processing of the upper level of the caller of the battery display processing.

On the other hand, when it is determined that the display is updated (YES in S111) or when it is determined that the display is switched (YES in S112), CPU 301 calculates SOC of the present battery 100 and the expected range according to SOC (S113). The cruising distance is, for example, a value obtained by dividing the electric storage amount corresponding to the present SOC by the mean electric cost. The average electricity cost may be a catalog value or a latest learned value. When the temperature is being controlled, the cruising distance considering the amount of electric power used for the temperature control is calculated as the cruising distance. In addition, the cruising distance may be calculated by considering factors affecting the cruising distance, such as the weight of electrified vehicle 1 and the temperature.

Next, CPU 301 determines whether the temperature of the battery 100 is being controlled by the cooling/temperature raising device 800 (S114). If it is determined that the temperature is not being controlled (NO in S114), CPU 301 calculates an amount of electric power that is reduced by the use of the temperature control until the power loss when the temperature control is started, a decreasing SOC corresponding to the amount of electric power, and a decreasing range corresponding to the amount of electric power (S115). Incidentally, by increasing the amount of electric power that can be output from the battery 100 by executing the temperature control, by subtracting the amount of electric power used for the temperature control, when the temperature control is started, the amount of electric power by use for the temperature control may be increased.

On the other hand, when it is determined that the temperature is being controlled (YES in S114), CPU 301 calculates an amount of electric power that is increased by not being used for the temperature control until the lack of electricity when the temperature control is stopped, an increasing SOC corresponding to the amount of electric power, and an increasing range corresponding to the amount of electric power (S116). Note that, since the amount of electric power that can be output from the battery 100 is not increased by not performing temperature control, the amount of electric power that is not used for temperature control may be reduced by subtracting the amount of electric power that is not used for temperature control, and the amount of electric power that is not used for temperature control until the time when the temperature control is stopped.

After S115 or S116, CPU 301 determines whether the destination is being set by the navigation device 600 (S117). If it is determined that the destination is being set (YES in S117), CPU 301 calculates the expected SOC and the range corresponding to SOC when the vehicle arrives at the destination when the temperature is controlled or not (S118).

If it is determined that the destination is not being set (NO in S117), or after S118, CPU 301 determines in the meter panel 305 whether or not the display related to the storage amount of the battery 100 is being displayed in the form of the remaining amount display. Alternatively, CPU 301 determines whether or not the display related to the storage amount of the battery 100 has been switched to the mode of the remaining amount display (S121). When CPU 301 determines that the display is being performed in the remaining amount display mode or that the display is switched to the remaining amount display mode (YES in S121), CPU 301 displays the display related to the storage amount of the battery 100 in the remaining amount display mode on the meter panel 305 using the calculation results of S113, S115 and S116 (S122).

FIG. 3A and FIG. 3B are diagrams illustrating an aspect of a display of the remaining amount of the display regarding the storage amount of the battery 100 in the meter panel 305 according to the embodiment. As shown in FIG. 3A, in the aspect of the remaining amount indication, the present SOC is displayed in the aspect of a bar graph indicated by thin hatching. At the same time, SOC decreased (or increased) by the temperature control is displayed in the form of a bar graph indicated by thick hatching.

It should be noted that, as shown in FIG. 3B as a modification, the present SOC is displayed in the form of a bar graph indicated by thin hatching in the upper row. At the same time, SOC obtained by subtracting the decreasing (or increasing) SOC from the present SOC may be displayed in the form of a bar graph indicated by thin hatching in the lower row.

Returning to FIG. 2, when CPU 301 determines that the display is not being performed in the remaining amount display mode and that the display is not switched to the remaining amount display mode (NO in S121), CPU 301 determines, on the meter panel 305, whether or not the display related to the storage amount of the battery 100 is being performed in SOC display mode. Alternatively, CPU 301 determines whether or not the display related to the storage capacity of the battery 100 has been switched to SOC display mode (S123). When SOC display mode is displayed or when SOC display mode is switched (YES in S123), CPU 301 determines that the display mode is displayed, CPU 301 displays (S124) the display related to the storage capacity of the battery 100 on the meter panel 305 in SOC display mode using the calculated S113, S115 and S116.

FIG. 4A to FIG. 4D are diagrams showing SOC display modes of the display regarding the storage capacity of the battery 100 in the meter panel 305 in this embodiment. As shown in FIG. 4A, when the temperature of the battery 100 is not being controlled, in the mode of displaying SOC, the present SOC is displayed as a numerical value (a numerical value of “82%” in FIG. 4A) on the left side in the display frame as a numerical value when the temperature control is continued. On the other hand, a SOC obtained by subtracting SOC (9% in FIG. 4A) that is decreased (or increased) by temperature control from the present SOC (82% in FIG. 4A) is displayed as a numerical value when temperature control is started, with a numerical value (a numerical value of “73%” in FIG. 4A) on the right side in the frame.

As shown in FIG. 4B, when the temperature of the battery 100 is being controlled, in SOC display mode, a SOC obtained by subtracting SOC (9% in FIG. 4B) which is decreased (or increased) by the temperature control from the present SOC (82% in FIG. 4B) is displayed as a numerical value (a numerical value of “73%” in FIG. 4B) on the left side in the display frame as a numerical value when the temperature control is continued. On the other hand, the present SOC is displayed by a numerical value (a numerical value of “82%” in FIG. 4B) on the right side of the frame as a numerical value when the temperature control is stopped.

Note that a modification of FIG. 4A is shown in FIG. 4C. When the temperature of the battery 100 is not being controlled, in SOC display mode, the present SOC is displayed as a numerical value (a numerical value of “82%” in FIG. 4C) on the left side in the display frame as a numerical value when the temperature control is continued, as in the case of FIG. 4A. On the other hand, unlike FIG. 4A, SOC of decreasing (or increasing) by the temperature control may be displayed by a numerical value (a numerical value of “−9%” in FIG. 4C) on the right side in the frame as a numerical value when the temperature control is started.

Further, a modification of FIG. 4B is shown in FIG. 4D. When the temperature of the battery 100 is being controlled, in SOC displaying mode, as in FIG. 4B, a SOC obtained by subtracting the SOC (9% in FIG. 4D) decreased (or increased) by the temperature control is displayed as a numerical value (a numerical value of “73%” in FIG. 4D) on the left side in the display frame as a numerical value when the temperature control is continued from the present SOC (82% in FIG. 4D). On the other hand, unlike FIG. 4B, as a numerical value when the temperature control is stopped, a SOC to be increased (or decreased) by stopping the temperature control may be displayed by a numerical value (a numerical value of “+9%” in FIG. 4D) on the right side in the frame.

Returning to FIG. 2, when it is determined that the display is not being performed in SOC display mode and is not switched to SOC display mode (NO in S123), CPU 301 determines, in the meter panel 305, whether or not the display related to the power storage amount of the battery 100 is being performed in the cruising distance display mode. Alternatively, CPU 301 determines whether or not the display related to the power storage capacity of the battery 100 has been switched to the mode of the cruising distance display (S125). When CPU 301 determines that the vehicle is being displayed in the mode of the cruising distance display or has been switched to the mode of the cruising distance display (YES in S125), CPU 301 uses the calculated S113, S115 and S116 to display the display related to the storage capacity of the battery 100 in the mode of the cruising distance display on the meter panel 305 (S126).

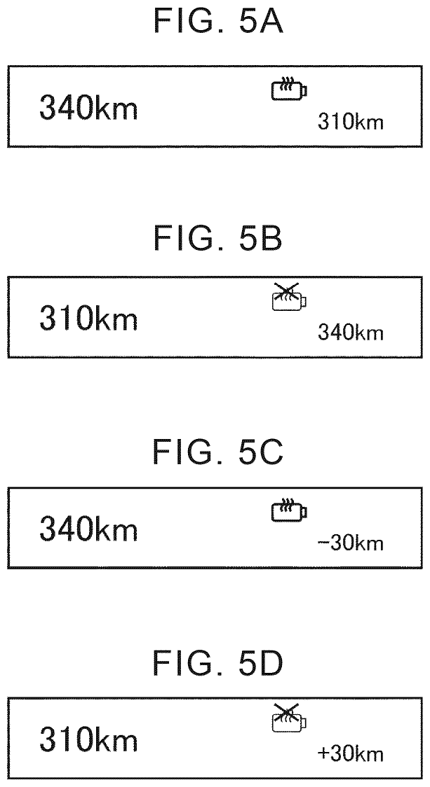

Each of FIG. 5A to FIG. 5D illustrates an aspect of a cruising distance display of a display relating to the electric storage capacity of the battery 100 in the meter panel 305 according to the present embodiment. As shown in FIG. 5A, when the temperature of the battery 100 is not being controlled, in the mode of the cruising distance display, the present cruising distance is displayed as a numerical value (a numerical value of “340 km” in FIG. 5A) on the left side in the display frame as a numerical value when the temperature control is continued. On the other hand, as the numerical value when the temperature control is started, the cruising distance obtained by subtracting the cruising distance (in FIG. 5A, 30 km) which is decreased (or increased) by the temperature control from the present cruising distance (340 km in FIG. 5A) is displayed by a numerical value (in FIG. 5A, the numerical value of “310 km”) on the right side of the frame.

As shown in FIG. 5B, when the temperature of the battery 100 is being controlled, as a numerical value when the temperature control is continued, in the mode of the cruising distance display, the cruising distance obtained by subtracting the cruising distance (30 km in FIG. 5B) which is decreased (or increased) by the temperature control from the present cruising distance (340 km in FIG. 5B) is displayed as a numerical value (numerical value with “310 km” in FIG. 5B) on the left side in the display frame. On the other hand, the present range is indicated by a numerical value (in FIG. 5B, a numerical value of “340 km”) on the right side of the frame as a numerical value when the temperature control is stopped.

Note that a modification of FIG. 5A is shown in FIG. 5C. When the temperature of the battery 100 is not being controlled, in the mode of the cruising distance display, as in FIG. 5A, the present cruising distance is displayed as a numerical value (a numerical value of “340 km” in FIG. 5C) on the left side in the display frame as a numerical value when the temperature control is continued. On the other hand, unlike FIG. 5A, the cruising distance that is decreased (or increased) by the temperature control may be displayed as a numerical value when the temperature control is started, on the right side in the frame (a numerical value of “−30 km” in FIG. 5C).

Further, a modification of FIG. 5B is shown in FIG. 5D. When the temperature of the battery 100 is being controlled, in the mode of the cruising distance display, as in FIG. 5B, the cruising distance obtained by subtracting the cruising distance (30 km in FIG. 5D) which is decreased (or increased) by the temperature control from the present cruising distance (340 km in FIG. 5D) as a numerical value when the temperature control is continued is displayed as a numerical value (numerical value with “310 km” in FIG. 5D) on the left side in the display frame. On the other hand, unlike FIG. 5B, the cruising distance that is increased (or decreased) by stopping the temperature control may be displayed as a numerical value when the temperature control is stopped, on the right side in the frame (a numerical value of “+30 km” in FIG. 5D).

Returning to FIG. 2, when CPU 301 determines that the vehicle is not being displayed in the mode of the cruising distance display and that the vehicle is not switched to the mode of the cruising distance display (NO in S125), CPU 301 determines in the meter panel 305 whether or not the display related to the storage amount of the battery 100 is being displayed in the mode of the arrival time display. Alternatively, CPU 301 determines whether or not the display related to the storage capacity of the battery 100 has been switched to the arrival-time display mode (S127). When CPU 301 determines that the display is in the arrival-time display mode or the display is switched to the arrival-time display mode (YES in S127), CPU 301 uses the calculation result of S118 to display the display regarding the storage amount of the battery 100 in the arrival-time display mode on the meter panel 305 (S128).

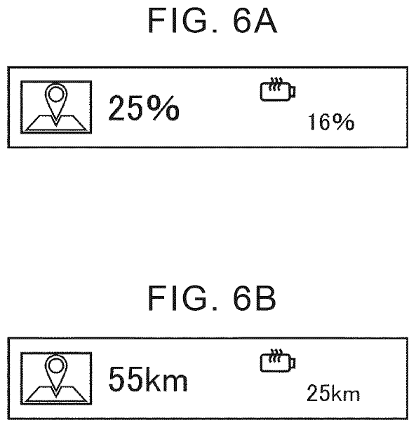

FIG. 6A and FIG. 6B are diagrams illustrating an aspect of an arrival-time display of the display regarding the amount of power stored in the battery 100 in the meter panel 305 in this embodiment. As shown in FIG. 6A, in the arrival-time display mode, SOC when the temperature is not adjusted, which is expected when the vehicle arrives at the destination set by the navigation device 600, is displayed as a numerical value (a numerical value of “25%” in FIG. 6A) on the left side in the display frame. On the other hand, SOC at the time of temperature adjustment expected when arriving at the destination set by the navigation device 600 is displayed by a numerical value (a numerical value of “16%” in FIG. 6A) on the right side in the displaying frame.

As a modification of FIG. 6A, as shown in FIG. 6B, in the arrival display mode, the cruising distance when the temperature is not controlled, which is expected when the vehicle arrives at the destination set by the navigation device 600, is displayed as a numerical value (a numerical value of “55 km” in FIG. 6B) on the left side in the display frame. On the other hand, the cruising distance at the time of temperature adjustment expected when the vehicle arrives at the destination set by the navigation device 600 may be displayed by a numerical value (a numerical value of “25 km” in FIG. 6B) on the right side in the frame.

Returning to FIG. 2, if CPU 301 determines after S122, after S124, after S126, after S128, or when the display is not being performed in the display mode at the time of arrival and is not switched to the display mode at the time of arrival (NO in S127), CPU 301 returns the processing to be executed to the processing at the upper level of the caller of the battery display processing.

### Modifications

(1) In the above-described embodiment, as illustrated in FIG. 2, the mode of display regarding the amount of power stored in the battery 100 in the meter panel 305 is switched to the mode of display of the remaining amount, the mode of display of SOC, the mode of the cruising distance display, and the mode of the arrival time display during traveling. However, the present disclosure is not limited thereto, and at least two or more of the four display modes may be selectively switched.

In addition, when electrified vehicle 1 is traveling or when the destination of electrified vehicle 1 is set, the mode of display relating to the storage capacity of the battery 100 in the meter panel 305 is preferentially displayed in the mode of the cruising distance display (refer to FIG. 5A to FIG. 5D, and FIG. 6B). On the other hand, when the external charging of the battery 100 or the charging connector 420,520 is connected to electrified vehicle 1, the mode of displaying SOC (refer to FIG. 3A, FIG. 3B, FIG. 4A to FIG. 4D, and FIG. 6A) may be preferentially displayed. The first display mode may be preferentially displayed in comparison with the second display mode, so that only the first display mode can be displayed. Preferentially displaying the first display mode compared to the second display mode may be displaying the first display mode prior to the second display mode. Preferentially displaying the first display mode compared to the second display mode may be displaying the first display mode in a normal state, while the second display mode may be displayed when a predetermined operation is performed by the user.

(2) In the above-described embodiment, CPU 301 of ECU 300 executes the battery displaying process illustrated in FIG. 2. However, the processor executing the battery-displaying process is not limited thereto, and may be another processor, for example, an CPU 701 of HMI device 700 or an CPU 601 of the navigation device 600.

(3) In the above-described embodiment, the meter panel 305 displays a display related to the amount of power stored in the battery 100. However, the present disclosure is not limited thereto, and the display regarding the amount of power storage of the battery 100 may be displayed on another display device such as the touch panel display 704 of HMI device 700 or the touch panel display of the user terminal 3.

(4) The above-described embodiment can be regarded as disclosing a display device such as the meter panel 305, the touch panel display 704 of HMI device 700, or the touch panel display of the user terminal 3. The embodiments described above can be viewed as disclosing vehicles such as electrified vehicle 1 including the display device. The above-described embodiments can be regarded as disclosure of a display method or a program relating to the amount of electricity stored in the battery 100 in the display device or the vehicle.

### Summary

(1) As illustrated in FIG. 1, electrified vehicle 1 includes a processor, a display device, a battery 100 that stores power for traveling, and a cooling/temperature raising device 800 that adjusts the temperature of the battery 100 in response to a user's manipulation using the power stored in the battery 100. The processor is, for example, an CPU of CPU 601, user terminal 3 of CPU 701, navigation device 600 of CPU 301, HMI device 700 of ECU 300. The display device is, for example, a touch panel display of the meter panel 305, HMI device 700 or a touch panel display of the user terminal 3. As shown in FIG. 2 to FIG. 6B, the processor calculates a comparison index value for the amount of power storage of the battery 100 between the case and the case of not operating the cooling/temperature raising device 800 (e.g., S113, S115, S116, S118), and displays the calculated comparison index value on the display device (e.g., S122, S124, S126, S128, see FIG. 3A to FIG. 6B).

This makes it possible to inform the user of electrified vehicle 1 of the power storage capacity of the battery 100 between the case where the cooling/temperature raising device 800 is operated and the case where it is not operated. The cooling/temperature raising device 800 is a device that adjusts the temperature of the battery 100 in accordance with a user's manipulation by using the electric power stored in the battery 100 that stores the electric power for traveling of electrified vehicle 1. As a result, it is possible to easily inform the user of information regarding the amount of electric power stored in the battery 100.

(2) As illustrated in FIG. 6A and FIG. 6B, the comparative index may be a parameter (for example, a SOC, cruising distance) relating to the amount of electricity stored when the target of the cooling/temperature raising device 800 is reached.

As a result, it is possible to easily inform the user of the information on the amount of stored electricity when the cooling/temperature-raising device 800 reaches the destination between the case of operating and the case of not operating.

(3) As illustrated in FIG. 2 to FIG. 5D, the comparative index may be a parameter (for example, a SOC, cruising distance) corresponding to the amount of stored electricity that is reduced by use of the cooling/temperature raising device 800 until the battery 100 is unable to travel due to electric power.

As a result, it is possible to easily inform the user of information on the amount of stored electricity that is reduced by the use of the cooling/temperature-raising device 800 until the battery 100 becomes unable to travel due to electric power.

(4) As shown in FIG. 2 to FIG. 6B and Modification (1), when electrified vehicle 1 travels or electrified vehicle 1 destination is set as the comparative index value, the value regarding the cruising distance is preferentially displayed as the comparative index value. When the external charging of the battery 100 or the connector 420,520 for charging is connected to electrified vehicle 1, the value related to SOC may be preferentially displayed as the comparative index value.

This allows values relating to the range or values relating to SOC to be communicated to the user selectively, depending on the circumstances. As a result, the convenience of the user can be improved.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. An electrified vehicle that informs a user of information about electric power for travel, comprising:
a processor;
a display device;
a power storage device that stores electric power for travel; and
a temperature adjusting device that adjusts a temperature of the power storage device according to an operation by the user using the electric power stored in the power storage device, wherein the processor is configured to:
calculate a comparison index value relating to a power storage amount of the power storage device in a case where the temperature adjusting device is caused to operate and a case where the temperature adjusting device is not caused to operate; and
cause the display device to display the calculated comparison index value.

2. A display device that informs a user of information about electric power for travel of an electrified vehicle, wherein the display device is caused to display a comparison index value relating to a power storage amount of a power storage device that stores electric power for travel in a case where a temperature adjusting device that adjusts a temperature of the power storage device is caused to operate and a case where the temperature adjusting device is not caused to operate.

3. The display device according to claim 2, wherein the comparison index value is a parameter relating to the power storage amount at a time when a destination is reached in a case where the temperature adjusting device is caused to operate and a case where the temperature adjusting device is not caused to operate.

4. The display device according to claim 2, wherein the comparison index value is a parameter corresponding to the power storage amount that is reduced by use of the temperature adjusting device before it becomes impossible to travel using the electric power in the power storage device.

5. The display device according to claim 2, wherein:
a value relating to a cruising distance is preferentially displayed as the comparison index value while the electrified vehicle is traveling or when a destination of the electrified vehicle is set; and
a value relating to a state of charge (SOC) is preferentially displayed as the comparison index value while the power storage device is being externally charged or when a charging plug is connected to the electrified vehicle.
